(19) United States
(12) Patent Application Publication
(10) Pub. No.: US 2026/0241502 A1
(43) Pub. Date: Aug. 20, 2026

(54) TOOL HOLDER DEVICE OF TOOL MAGAZINE

(71) Applicant: SHIN-YAIN INDUSTRIAL CO., LTD., Taichung City (TW)

(72) Inventor: PEN HUNG CHEN, Taichung City (TW)

(21) Appl. No.: 19/055,113

(22) Filed: Feb. 17, 2025

(51) Int. Cl. B23Q 3/155

(52) U.S. Cl. CPC B23Q 3/15526

(57) ABSTRACT

A tool holder device has a tool holder assembly, a positioning unit, and an auxiliary wrench. The tool holder assembly has a tool holder for receiving a cutter holder. The tool holder has an engaging section. The positioning unit is detachably assembled to the tool holder assembly and has a board and at least one restricting protrusion. Each restricting protrusion is disposed at a surface of the board. The auxiliary wrench has an engaging recessed-portion and at least one restricting recessed-portion. The engaging recessed-portion is able to engage with the engaging section and has an opening disposed at a periphery of the auxiliary wrench. Each restricting recessed-portion is able to engage with each restricting protrusion and has an opening disposed at the periphery of the auxiliary wrench. The opening of each restricting recessed-portion and the opening of the engaging recessed-portion are oriented toward a same direction.

### BACKGROUND OF THE INVENTION

### 1. Field of the Invention

The present invention relates to a device for holding a cutter holder, and more particularly to a tool holder device mounted to a tool magazine and configured to hold a cutter holder for holding a cutter.

### 2. Description of Related Art

To achieve various functions, the structure of a workpiece is getting more and more complex. Various cutters for different machining purposes are applied to machine the workpiece. Consequently, different portions of the workpiece can be formed by machining to achieve the various functions.

In the machining industry, a tool magazine is adapted in a machining system for receiving cutters corresponding to various functions. With reference to FIGS. 7 and 8, a tool magazine has a driving mechanism 60, a magazine frame 70 driven by the driving mechanism 60, and at least one tool holder device 80 mounted to the magazine frame 70.

Wherein, each tool holder device 80 is configured to hold a cutter holder 90 for holding a cutter 100. Each tool holder device 80 has a mount 81, a tool holder 82 inserted in the mount 81, and a fixing lid 83 screwed with the tool holder 82. The cutter holder 90 is mounted by the cutter 100 and is inserted in the tool holder 82.

In the conventional tool holder device 80 shown in FIGS. 7 and 8, the staff has to hold two wrenches respectively engaging with the tool holder 82 and the fixing lid 83 to rotate the tool holder 82 and the fixing lid 83 relative to each other for replacing the cutter 100.

However, the structure of the conventional tool holder device 80 requires the two wrenches rotating by two hands to replace the cutter 100, which is hard to proceed in a small space.

To overcome the shortcomings of the conventional tool holder device, the present invention provides a tool holder device of a tool magazine to mitigate or obviate the aforementioned problems.

### SUMMARY OF THE INVENTION

The main objective of the present invention is to provide a tool holder device that is configured to conveniently replace a cutter in a small space.

The tool holder device has a tool holder assembly, a positioning unit, and an auxiliary wrench. The tool holder assembly has a tool holder for receiving a cutter holder. The tool holder has an engaging section. The positioning unit is detachably assembled to the tool holder assembly and has a board and at least one restricting protrusion. Each restricting protrusion is disposed at a surface of the board. The auxiliary wrench has an engaging recessed-portion and at least one restricting recessed-portion. The engaging recessed-portion is able to engage with the engaging section and has an opening disposed at a periphery of the auxiliary wrench. Each restricting recessed-portion is able to engage with each restricting protrusion and has an opening disposed at the periphery of the auxiliary wrench. The opening of each restricting recessed-portion and the opening of the engaging recessed-portion are oriented to a same direction.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a tool magazine and shows that a tool holder device in accordance with the present invention is assembled to the tool magazine;

FIG. 2 is a perspective view of a tool holder assembly and a positioning unit of the tool holder device in FIG. 1;

FIG. 3 is another perspective view of the tool holder device and shows that an auxiliary wrench of the tool holder device is assembling to the tool holder assembly in FIG. 2;

FIG. 4 is a top view of the tool holder device in FIG. 3 and shows that the auxiliary wrench is assembled to the tool holder assembly at one side;

FIG. 5 is another top view of the tool holder device in FIG. 3 and shows that the auxiliary wrench is assembled to the tool holder assembly at the other side;

FIG. 6 is a schematic diagram of the tool holder device in FIG. 3 and shows a wrench engages with a fixing lid of the tool holder assembly;

FIG. 7 is a perspective view of a tool magazine and shows that a conventional tool holder device is assembled to the tool magazine; and

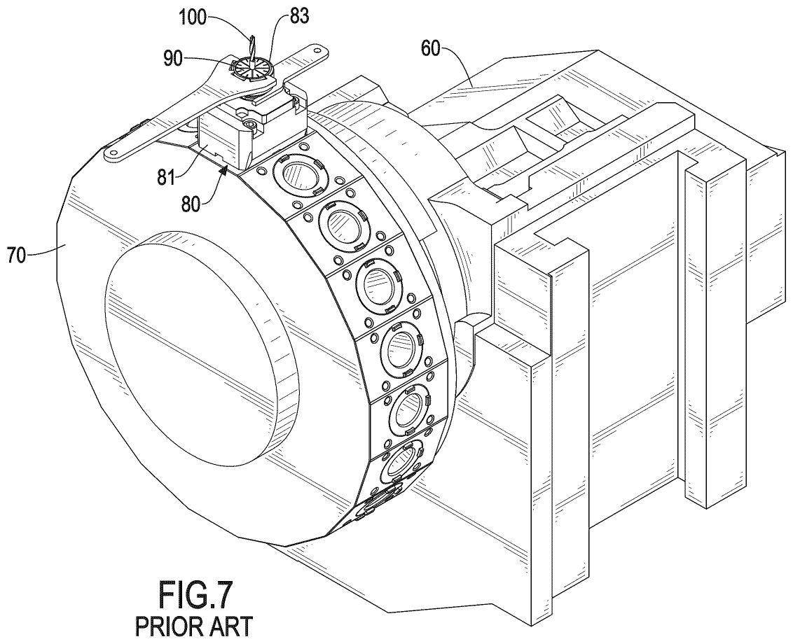

FIG. 8 is a perspective view of the conventional tool holder device in FIG. 7.

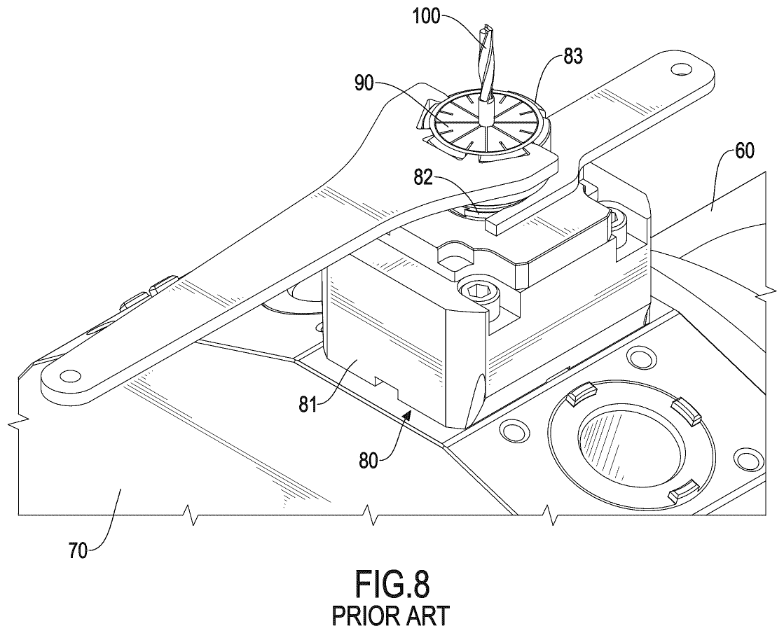

### DETAILED DESCRIPTION OF PREFERRED EMBODIMENTS

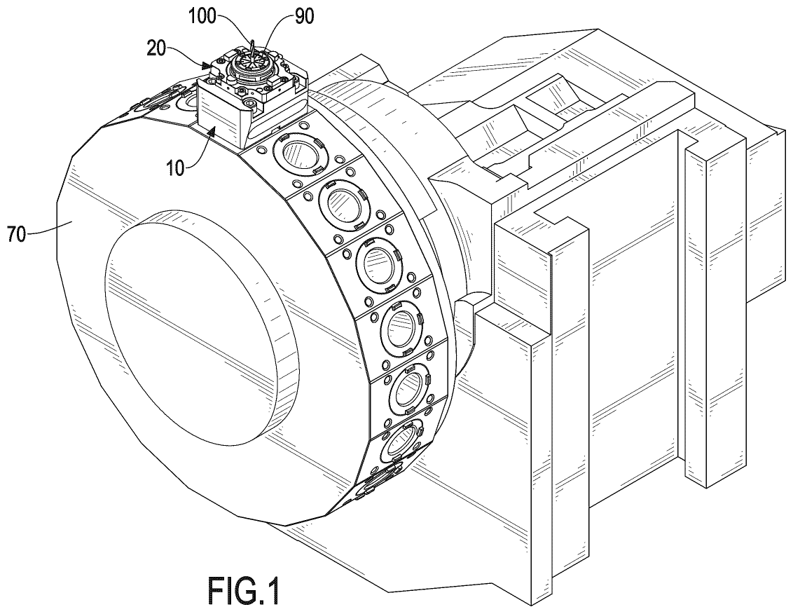

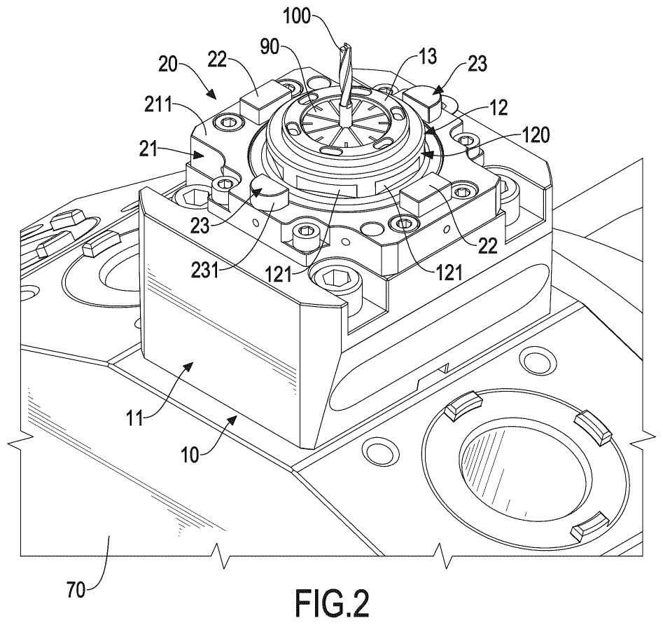

With reference to FIGS. 1 to 3, a tool holder device in accordance with the present invention is configured to be assembled to a magazine frame 70 of a tool magazine. An embodiment of the tool holder device has a tool holder assembly 10, a positioning unit 20, and an auxiliary wrench 30.

With reference to FIGS. 1 to 3, the tool holder assembly 10 is assembled to the magazine frame 70 and is configured to hold a cutter holder 90. Wherein, the cutter holder 90 is mounted by a cutter 100. The tool holder assembly 10 has a mount 11, a tool holder 12 inserted in the mount 11, and a fixing lid 13 screwed with the tool holder 12. The tool holder 12 is configured to hold the cutter holder 90 and has an engaging section 120. The engaging section 120 has multiple pairs of engaging faces. Each of the multiple pairs of engaging faces has two engaging faces 121 parallel to each other and facing to opposite directions. Detailed structures of the tool holder assembly 10 are common knowledge and are not further elaborated.

With reference to FIGS. 1 to 3, the positioning unit 20 is detachably assembled to a top of the mount 11 of the tool holder assembly 10 by bolts. The positioning unit 20 has a board 21, two restricting protrusions 22, and two positioning protrusions 23. Wherein, the board 21 has two surfaces facing to opposite directions. One of the two surfaces of the board 21 contacts the top of the mount 11. The two restricting protrusions 22 and the two positioning protrusions 23 are formed at the other surface 211 of the board 21.

With reference to FIGS. 1 to 3, the two restricting protrusions 22 are opposite each other in position. Each one of the restricting protrusions 22 has a rectangular contour. Each one of the positioning protrusions 23 has an abutted face 231 being curved and facing to a periphery of the board 21. The two positioning protrusions 23 are opposite each other in position. The two abutted faces 231 of the two positioning protrusions 23 face to opposite directions.

With reference to FIGS. 1 to 3, the auxiliary wrench 30 is configured to restrict the tool holder 12 from rotating. The auxiliary wrench 30 is a plate and has an engaging recessed-portion 31, two restricting recessed-portions 32, a positioning recessed-portion 33, and a through hole 34. The engaging recessed-portion 31 has a contour corresponding to a contour of the engaging section 120 of the tool holder 12. The engaging recessed-portion 31 is able to engage with the engaging section 120 accordingly. The engaging recessed-portion 31 has an opening disposed at a periphery of the auxiliary wrench 30, a bottom face 311 opposite to said opening in position, and two engaging abutting-faces 313 opposite to each other in position and parallel to each other. The two engaging abutting-faces 313 are able to respectively abut against the two engaging faces 121 of each one of the multiple pairs of engaging faces.

With reference to FIGS. 1 to 3, the two restricting recessed-portions 32 are respectively disposed at opposite two sides of the engaging recessed-portion 31. Each one of the restricting recessed-portions 32 has a contour corresponding to the contour of each restricting protrusion 22. Each restricting recessed-portion 32 is able to engage with each restricting protrusion 22 accordingly. Each one of the restricting recessed-portions 32 has an opening disposed at the periphery of the auxiliary wrench 30. The opening of each restricting recessed-portion 32 and the opening of the engaging recessed-portion 31 are oriented toward a same direction.

With reference to FIGS. 1 to 4, the positioning recessed-portion 33 is formed at the bottom face 311 of the engaging recessed-portion 31 and has a positioning abutting-face 331. The positioning recessed-portion 33 has a contour corresponding to a contour of each one of the positioning protrusions 23. The positioning recessed-portion 33 is able to engage with each positioning protrusion 23 accordingly. The positioning abutting-face 331 of the positioning recessed-portion 33 is opposite to the bottom face 311 of the engaging recessed-portion 31 in position. The positioning abutting-face 331 is curved, corresponds to each abutted face 231 being curved in shape, and is able to abut against the abutted face 231 of each one of the two positioning protrusions 23. The through hole 34 and the engaging recessed-portion 31 of the auxiliary wrench 30 are respectively adjacent to opposite two sides of the auxiliary wrench 30.

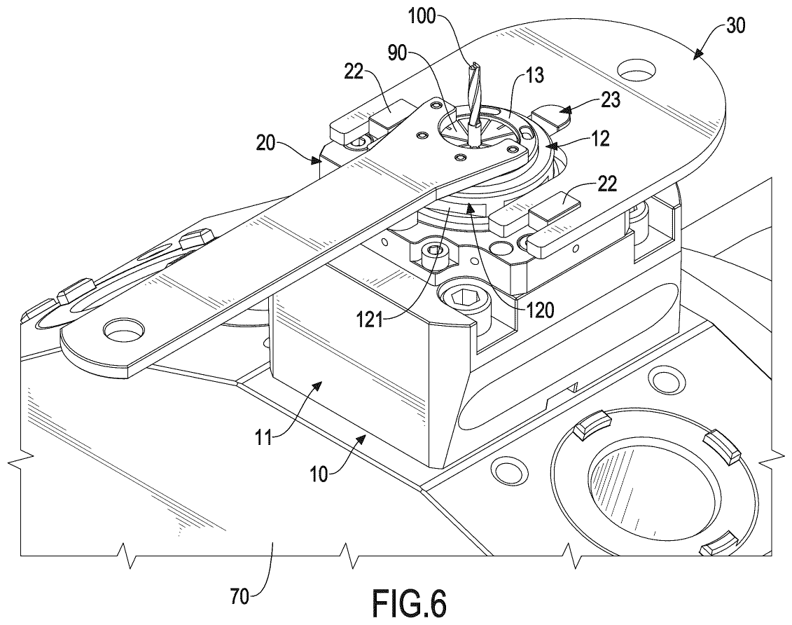

With reference to FIGS. 1 to 4 and 6, when the cutter 100 mounted to the cutter holder 90 needs to be replaced, the auxiliary wrench 30 can be assembled to the positioning unit 20 by a staff member. Consequently, the engaging recessed-portion 31 of the auxiliary wrench 30 engages with the engaging section 120 of the tool holder 12, the two restricting recessed-portions 32 respectively engage with the two restricting protrusions 22 of the positioning unit 20 fixed to the mount 11, and the positioning recessed-portion 33 engages with one of the two positioning protrusions 23 of the positioning unit 20, and the positioning abutting-face 331 of the positioning recessed-portion 33 abuts against the abutted face 231 of said positioning protrusion 23.

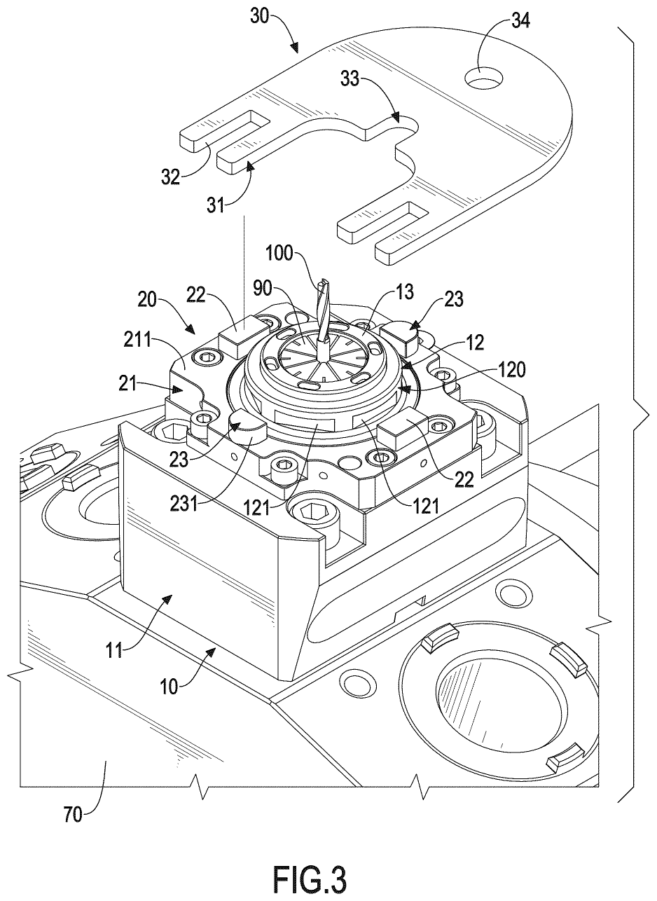

With reference to FIGS. 3 to 5, the two engaging abutting-faces 313 of the engaging recessed-face 31 respectively abut against the two engaging faces 121 of one of the multiple pairs of engaging faces, and each one of the restricting recessed-portions 32 engages with a corresponding one of the restricting protrusions 22. Therefore, the tool holder 12 cannot rotate relative to the positioning unit 20 and the mount 11. Meanwhile, the staff can engage the fixing lid 13 via a wrench to loosen the fixing lid 13 for replacing the cutter 100 mounted to the cutter holder 90.

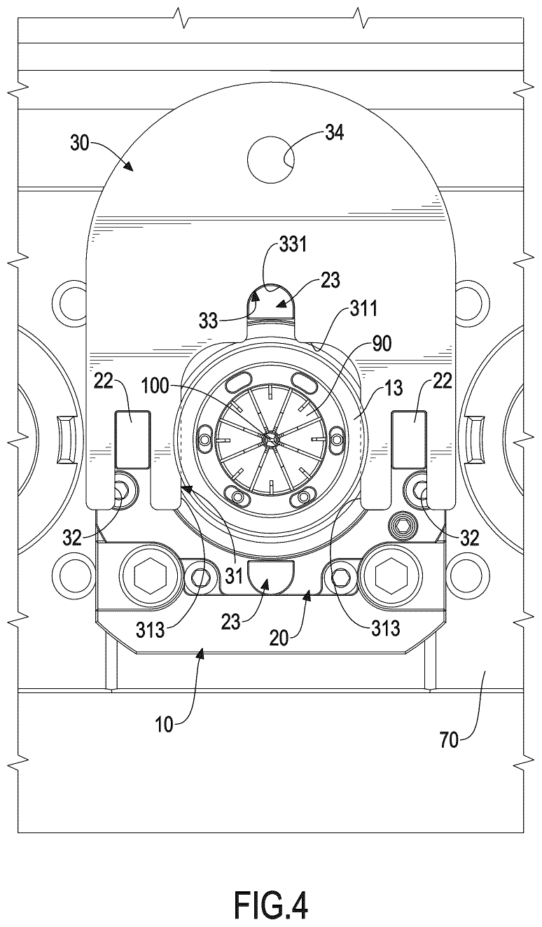

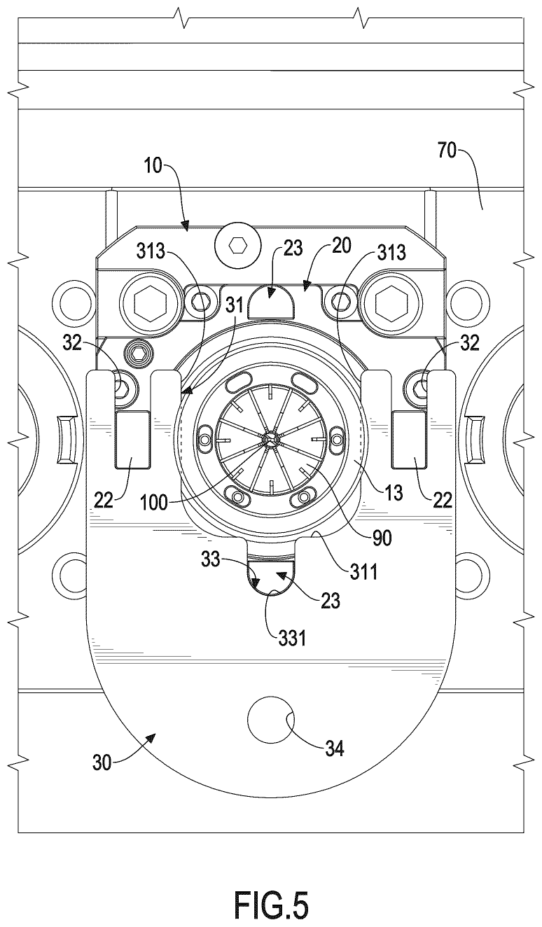

With reference to FIGS. 4 and 5, the two abutted faces 231 of the two positioning protrusions 23 of the positioning unit 20 face to opposite directions. Therefore, the staff can assemble the auxiliary wrench 30 to the tool holder assembly 10 at a side with a smaller space and operate the wrench at the other side with a larger space. The cutter 100 can be replaced by loosening or tightening the fixing lid 13.

In a conventional tool holder device 80, the staff has to hold two wrenches with two hands to loosen or to tighten a tool holder 82 and a fixing lid 83 of the conventional tool holder device 80. Compared to the conventional tool holder device 80, the auxiliary wrench 30 can be assembled to the tool holder assembly 10 at the side with the smaller space to prevent the tool holder 12 from rotating. The staff is free from operating the wrench in a small space, but also can operate the wrench with one hand or both two hands to rotate the fixing lid 13. Consequently, the staff can easily apply force to the fixing lid 13 to achieve a convenient process of replacing the cutter.

In addition, the positioning unit 20 has the two positioning protrusions 23 opposite each other in position. The two abutted faces 231 of the two positioning protrusions 23 face to opposite directions, the positioning abutting-face 331 of the positioning recessed-portion 33 can firmly abut against the abutted face 231 of a corresponding one of the positioning protrusions 23 regardless that the auxiliary wrench 30 is assembled on either of the sides of the tool holder assembly 10. The auxiliary wrench 30 firmly engages with the positioning unit 20 to indeed prevent the tool holder 12 from rotating.

In the embodiment of the tool holder device in accordance with the present invention, the positioning unit 20 has the two restricting protrusions 22 and the two positioning protrusions 23, and the auxiliary wrench 30 has the two restricting recessed-portions 32. Practically, the positioning unit 20 may have one single said restricting protrusion 22, one single said positioning protrusion 23, and the auxiliary wrench 30 may have one single said restricting recessed-portion 32, as long as the tool holder 12 is certainly free from rotating. The amount of said restricting protrusion 22, the amount of said positioning protrusion 23, and the amount of the said restricting recessed-portions 32 are not restricted.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A tool holder device comprising:
a tool holder assembly having a tool holder, the tool holder configured to receive a cutter holder and having an engaging section;
a positioning unit detachably assembled to the tool holder assembly and having a board and at least one restricting protrusion, each one of the at least one restricting protrusion disposed at a surface of the board; and
an auxiliary wrench having
an engaging recessed-portion able to engage with the engaging section and having an opening disposed at a periphery of the auxiliary wrench; and
at least one restricting recessed-portion, each one of the at least one restricting recessed-portion able to engage with each one of the at least one restricting protrusion and having an opening disposed at the periphery of the auxiliary wrench, the opening of each one of the at least one restricting recessed-portion and the opening of the engaging recessed-portion oriented toward a same direction.

2. The tool holder device as claimed in claim 1, wherein
the positioning unit has at least one positioning protrusion, each one of the at least one positioning protrusion and each one of the at least one restricting protrusion disposed at the same surface of the board;
the engaging recessed-portion has a bottom face opposite to the opening of the engaging recessed-portion; and
the auxiliary wrench has a positioning recessed-portion formed at the bottom face of the engaging recessed-portion and able to engage with each one of the at least one positioning protrusion.

3. The tool holder device as claimed in claim 2, wherein
each one of the at least one positioning protrusion has an abutted face being curved and facing to a periphery of the board; and
the positioning recessed-portion has a positioning abutting-face being curved, corresponding to the abutted face being curved in shape, and able to abut against the abutted face of each one of the at least one positioning protrusion.

4. The tool holder device as claimed in claim 3, wherein the at least one positioning protrusion includes two positioning protrusions.

5. The tool holder device as claimed in claim 1, wherein
the engaging portion has multiple pairs of engaging faces;
each one of the multiple pairs of engaging faces has two engaging faces parallel to each other and facing to opposite directions; and
the engaging recessed-portion has two engaging abutting-faces opposite to each other and able to respectively abut against the two engaging faces of each one of the multiple pairs of engaging faces.

6. The tool holder device as claimed in claim 2, wherein
the engaging portion has multiple pairs of engaging faces;
each one of the multiple pairs of engaging faces has two engaging faces parallel to each other and facing to opposite directions; and
the engaging recessed-portion has two engaging abutting-faces opposite to each other and able to respectively abut against the two engaging faces of each one of the multiple pairs of engaging faces.

7. The tool holder device as claimed in claim 3, wherein
the engaging portion has multiple pairs of engaging faces;
each one of the multiple pairs of engaging faces has two engaging faces parallel to each other and facing to opposite directions; and
the engaging recessed-portion has two engaging abutting-faces opposite to each other and able to respectively abut against the two engaging faces of each one of the multiple pairs of engaging faces.

8. The tool holder device as claimed in claim 4, wherein
the engaging portion has multiple pairs of engaging faces;
each one of the multiple pairs of engaging faces has two engaging faces parallel to each other and facing to opposite directions; and
the engaging recessed-portion has two engaging abutting-faces opposite to each other and able to respectively abut against the two engaging faces of each one of the multiple pairs of engaging faces.
